(19) United States
(12) Patent Application Publication
(10) Pub. No.: US 2022/0040643 A1
(43) Pub. Date: Feb. 10, 2022

(54) Modification of membrane surfaces with amino acid polymers

(71) Applicants: Qun Song, Gurnee, IL (US); Jane C. Li, Arlington Heights, IL (US); Norman N. Li, Arlington Heights, IL (US)

(72) Inventors: Qun Song, Gurnee, IL (US); Jane C. Li, Arlington Heights, IL (US); Norman N. Li, Arlington Heights, IL (US)

(73) Assignee: NL Chemical Technology, Inc., Mount Prospect, IL (US)

(21) Appl. No.: 16/947,506

(22) Filed: Aug. 4, 2020

(51) Int. Cl. B01D 65/08; B01D 71/56; B01D 69/12; B01D 69/10; B01D 67/00; B01D 61/02

(52) U.S. Cl. CPC B01D 65/08; B01D 71/56; B01D 69/12; B01D 2323/30; B01D 67/0093; B01D 61/025; B01D 2323/36; B01D 69/10

(57) ABSTRACT

Poly(amino acids) having hydrophilic side groups may be grafted onto active surfaces of polyamide composite membranes so as to confer fouling resistance. Polylysine, polyhistidine, polyarginine and their blends with polyglutamic acid may be grafted to membrane surfaces via amide linkages or via peroxide-induces bonding, modifying membrane surfaces behavior towards foulants.

### FIELD OF THE INVENTION

The invention relates to reverse osmosis membranes and their manufacture and use. More particularly, the invention relates to reverse osmosis membranes having coatings that provide improved resistance to fouling.

### BACKGROUND OF THE INVENTION

Reverse osmosis membranes are useful in treating seawater and brackish waters to produce potable water. Over the last few decades, these applications have grown rapidly, caused primarily by growing populations that put pressure on conventional water sources and outstrip their capacity. Increasingly, reverse osmosis membranes have also seen their usefulness expanded to various industrial process water applications and to wastewater reclamations. In many of these developing applications, the aqueous feed is contaminated with chemicals, organic compounds, and/or biological matter. Reverse osmosis membranes are susceptible to fouling by feed water contaminants. Accumulation of foulant layers on the exposed active surfaces of the membranes results in lowering of the productivity of the membranes, most notably in decreased water flux. Special attention is required to pretreatment of feed water and to cleaning cycles with their associated downtime. As new opportunities for membranes develop in municipal and industrial water applications, modification of membrane active surfaces by various chemical treatments have been and continue to be widely pursued to make membranes more resistant to fouling.

Most modern high-performance reverse osmosis membranes are made by interfacial reaction of aromatic amines with aromatic acyl halides at the surface of a microporous support layer. The resulting interfacially formed polyamide composite membranes have active surfaces that are rough, viewed on a microscopic scale. These membranes may trap suspended particles due to their rough surface topography. Deposition of surface coatings on these membranes is helpful in smoothing out such membrane surfaces and allowing improved removal of such particulate foulants in treatments with cleaning chemicals, helping to restore membrane productivity. Efforts to smooth the surface through application of hydrophilic coatings have been disclosed, including application of polyvinyl alcohol in U.S. Pat. No. 6,177,011 and application of a polyamide-polyether block copolymer in U.S. Pat. No. 7,490,725. The smoothed membranes showed reduced fouling.

Much attention has been devoted to polyalkylene oxide treatments, using graft-able species such as the amine-terminated versions marketed under the trade name Jeffamine, available from Huntsman Chemical. Coatings such as these follow a theme that fouling resistance is best achieved by surfaces that are electro-neutral and devoid of hydrogen bond donor sites. The best such coatings are presumed to be represented by polyalkylene oxides such as polyethylene oxide or its combination with polypropylene oxide=hence the interest in Jeffamine or other analogs like polyethylene oxide.

The invention being disclosed herein is a departure from this current theme of electro-neutral coatings devoid of hydrogen bond donor sites, and employs coating chemicals not previously considered for fouling resistant coatings on reverse osmosis membranes.

### SUMMARY OF THE INVENTION

It is now disclosed herein that certain amino acid polymers may be grafted onto the active surfaces of polyamide composite membranes with good effect. Thus, poly(amino acids), hereinafter designated as PAAs, having side groups that make them hydrophilic, are beneficial in fostering foulant resistance to composite membranes upon being grafted thereonto. Some specific examples of such PAAs, are polylysine, polyhistidine, polyarginine, and blends thereof with polyglutamic acid, Grafting may be accomplished by multiple methods: by reaction of amine side groups with residual acyl halide surface moieties remaining after interfacial polyamide formation; by peroxide-induced bonding of the PAAs to the composite membrane surface; and by coating with PAAs and then crosslinking in situ, such that the coating remains fixed in place on the polyamide surface. These specific methods are representative of grafting methods, other variations of which may become obvious to one of skill in the art upon practice of the invention as described here and following.

### DESCRIPTION OF THE INVENTION

A reverse osmosis membrane may be made of any material, and may take any form, so long as it is capable of performing reverse osmosis, that is, it is capable upon contact with a suitably pressurized feedwater of preferentially permeating water and rejecting dissolved solutes, particularly dissolved inorganic salts, in the pressurized feed water. Additionally, such membranes may also be utilized in a newer development in wastewater reclamation, called forward osmosis. In the context of the present invention, in its most fundamental aspect, the invention is a reverse osmosis membrane wherein a polyamide discriminating formed on the surface of a microporous layer has an additional layer of a PAA grafted onto its surface. The grafted layer optimally comprises a hydrophilic PAA and is located on the reverse osmosis membrane's top surface, which is the active surface to be exposed to a feed water in a membrane separation operation such as reverse osmosis. The porous underlayer is normally composed of an engineering plastic cast into the form of a microporous matrix and is usually prepared as by a phase inversion process. The microporous matrix may be formed in the shape of hollow fibers, tubules, or sheets; sheet-form membranes dominate the reverse osmosis industry. When manufactured in sheet-like form, the microporous matrix, i.e. underlayer of the reverse osmosis membrane is customarily further supported on a nonwoven fabric. The microporous matrix is most often composed of polysulfone. The membrane layer composition is often referred to by the appellation “thin film composite” membrane, or more simply as a “composite membrane” because of the multilayer construction of these membranes in commercial practice.

In commercial scale operations, composite membranes are typically made by coating a microporous support (matrix) with an aqueous solution of a monomer having a plurality of amino groups, i.e. a polyamine, as part of a continuous operation. The monomer may have primary or secondary amino groups and may be aromatic or aliphatic. Examples of preferred amine compounds include primary aromatic amines having two or more amino groups, particularly m-phenylenediamine, and secondary aliphatic amines having two or more amino groups, particularly piperazine. The amine monomer is typically applied to the microporous support as a solution in water. The aqueous solution contains from about 0.1 to about 20 weight percent, preferably from about 0.5 to about 6 weight percent of the amine. Once coated on the microporous support, excess aqueous amine solution may be optionally removed.

The coated microporous support is then contacted with a monomeric polyfunctional acyl halide preferably in a non-polar organic solvent, although the polyfunctional acyl halide may be delivered from a vapor phase (for polyacyl halides having enough vapor pressure). The polyfunctional acyl halides are preferably aromatic in nature and contain at least two and preferably three acyl halide groups per molecule. Because of their lower cost and greater availability, acyl chlorides are generally preferred over the corresponding acyl bromides or iodides. One particularly preferred polyfunctional acyl halide is trimesoyl chloride (1,3,5-benzenetricarbonyl chloride). The polyfunctional acyl halide is typically dissolved in a non-polar organic solvent in a range of from 0.01 to 10.0 percent by weight, (more preferably 0.05 to 3 weight percent), and delivered as part of a continuous coating operation. Suitable non-polar organic solvents are those which are capable of dissolving polyfunctional acyl halides and which are immiscible with water. Preferred solvents include those which do not pose a threat to the ozone layer and yet are sufficiently safe in terms of their flashpoints and flammability to undergo routine processing without having to undertake extreme precautions. Higher boiling hydrocarbons, i.e., those with boiling points greater than about 90° C. such as C8-C14 hydrocarbons and mixtures thereof have more favorable flashpoints than their C5-C7 counterparts but they are less volatile.

Once brought into contact with the aqueous amine solution coated on the microporous support, the polyfunctional acyl halide reacts with the amine at the water-solvent interface to form a crosslinked polyamide discriminating layer. The reaction time typically occurs within a few seconds but contact time is preferably from ten to sixty seconds to allow full development of a polyamide layer thickness, after which excess liquid is customarily removed, e.g., by way of an air knife, water baths and/or a dryer. Washing by sprays, curtain coaters, dip tanks or the like may be added to the membrane finishing process as needed or desired in addition to the interfacial reaction steps. The removal of the excess water and/or organic solvent is most conveniently achieved by drying at elevated temperatures, e.g., from about 40° C. to about 120° C., although air drying at ambient temperatures may be used. The result is an interfacially synthesized polyamide discriminating layer useful in reverse osmosis applications.

The grafting of the hydrophilic PAA to the composite membrane's upper surface (the surface to be contacted with the pressurized feed water) achieves an adherent coating. The term “adherent” is defined herein to indicate that the hydrophilic PAA remains in place on the polyamide discriminating layer during handling and routine operation of this membrane in water treatment applications involving osmosis and reverse osmosis, including normal flushing and cleaning treatments as would be utilized on fouled membranes, further including detergents, surfactants, and acidic or alkaline chemicals as intended for cleaning membrane surfaces. Grafting occurs when a PAA containing pendant amine groups interacts with the surface of freshly formed polyamide by interfacial synthesis.

Interfacially formed polyamide layers in commercial reverse osmosis membranes are both very thin and very irregular in thickness, being characterized as having a thickness varying typically from 400 Ångstroms to 2600 Ångstroms, with an average thickness of approximately 2000 Ångstroms. The PAA coating itself will range from one molecular layer to a few molecular layers in depth. In terms of thickness, the PAA coating ranges between 20 and 150 Ångstroms. More applicable is a PAA coating of 20 to 50 Ångstroms. At higher thicknesses than these, some portion of the PAA will tend to be loose and unbound to the underlying polyamide. Deposition of the PAA coating is preferably done from an aqueous solution containing 0.001 to 1.0 percent weight per volume of the PAA in water. Preferably, the aqueous solution is very dilute, containing 0.01 to 0.05 percent. Other components may be present in the aqueous PAA solution, including a surfactant, an acid or base for pH control, and a water miscible co-solvent. Anionic surfactants are preferred, useful examples being sodium lauryl sulfate and sodium dodecyl-benzenesulfonate. Application of the PAA coating may be accomplished by any of several methods, including knife over roll, Mayer rods, transfer rollers, sprays, dip tanks, and curtain coaters.

As per the present invention, a generally preferred mode is to deposit a surface coating of a hydrophilic-group-rich PAA onto the surface of a polyamide discriminating layer. Such PAAs include polylysine, polyarginine, polyhistidine and polyglutamic acid, but the suitable range of PAAs may also extend to hydrophilic PAA copolymers or blends of hydrophilic PAAs with each other or with their copolymers, and characterized by the presence of lysine, arginine, histidine, or glutamic acid moieties therein. The term “poly(amino acid)” as used herein may be defined as designating a polymeric or oligomeric form of an amino acid, pre-formed as such prior to being applied as a coating to the top surface of a composite membrane, and further characterized in being primarily a homopolymer of a hydrophilic amino acid being hydrophilic by reason of a second amino group (lysine, arginine or histidine) or a carboxylic acid group (glutamic acid). A particularly preferred mode is to deposit a surface coating of an amine-rich PAA as embodied in polylysine, polyarginine, and/or polyhistidine onto the surface of a freshly formed polyamide discriminating layer and graft through reaction with residual surface-borne acyl halide groups present thereon. A residual population of these acyl halide groups typically remains on the membrane top surface after conclusion of the interfacial polymerization that forms a polyamide discriminating layer. These residual groups present grafting sites for attachment of amine-containing PAAs. The PAA graft coating may be accomplished during a membrane fabrication process, e.g., after formation of a discriminating layer by interfacial polymerization of a polyamine and polyfunctional acyl halide but before initiation of any further processing steps, such as washing or treatment with flux-promoting glycerol dips. The PAA-modified membrane may be stored in a wet state or a dry state.

Alternate methods of fixating the PAA coating onto a membrane surface include treatment with chemicals that serve to crosslink or similarly insolubilize the PAA coating on the membrane surface. In one approach, one may insolubilize the coating by exposing to a peroxide and activating the peroxide by heat, ultraviolet light irradiation, a combination of both, or addition of a redox initiator. Examples of peroxides include hydrogen peroxide, benzoyl peroxide, and cumyl peroxide. In another approach, the PAA coating may be insolubilized by reaction with a dialdehyde such as glutaraldehyde. Cross linkages are formed by condensation of aldehyde groups with amine side groups. The reactions are conveniently augmented by addition of heat, by acidic catalysts, or by combinations of heat and acidic catalysts. Low concentrations of mineral acids are advantageously used in these aldehyde=based crosslinking reactions.

The phrase “fouling resistance” applied to the art of membranes, as used herein, is defined as making a membrane less susceptible to development of a fouling layer on the membrane surface and further making the removal of a fouling layer or foulant more facile in a membrane cleaning cycle treatment. It should be recognized that all osmosis membranes become fouled in practice. No anti-fouling coating will make a reverse osmosis membrane become fouling “proof”. An important issue in the field of forward osmosis and reverse osmosis membranes is the retention of favorable flux and solute rejections that are characteristic of the membrane in its clean state, Coatings such as the PAAs applied herein change the surface of the membrane face that would be in contact with a water-borne foulant, presenting a hydrophilic surface less susceptible to binding of a foulant, in this manner improving the fouling resistance of the underlying membrane. But the PAA coating further acts to facilitate the release a foulant deposit, including one composed of a biofilm or associated biomatter, promoting restoration of membrane performance characteristics, in contrast to what would be possible with no such PAA coating.

Membranes are commonly treated to cleaning cycles during long term operation, in that some fouling always occurs. In the case of PAA-coated membranes, cleaning is typically done with a consecutive combination of acid cleaning and alkaline cleaning. Acid cleaning is preferably done with a citric acid or ethylenediamine-tetra-acetic acid (EDTA) formulation modified to a pH of 3 or higher, and including a surfactant. Alkaline cleaning is preferably done with an alkaline formulation modified to a pH of 10 and containing also a surfactant.

The various PAA homopolymers are generally available through purveyors of laboratory chemicals. α-Polylysine is available from laboratory suppliers as a hydrochloride or hydrobromide salt in molecular weights varying from as low as 1000 to as high as 150,000. It is available as a racemic mixture, and as the levo (L) or dextro (D) forms as well. All three forms are applicable to grafting on the reverse osmosis membrane surface. Molecular weights of 1,000 to 1,000,000 are suitable. For purposes of this invention the racemic form in a molecular weight range of 20,000 to 50,000 is preferable, primarily based on lower cost. In the grafting step, it is generally optimal to first convert the polylysine acid salt to free polylysine, such as by neutralization with a base such as sodium hydroxide. This neutralization step may involve partial or total conversion of the acid salt to the free amine form. Polyarginine may be substituted in place of polylysine. Polyarginine is available commercially in the levo form as a hydrochloride salt at molecular weights ranging from 5,000 to greater than 70,000; all of these molecular weight grades would suffice. Racemic polyarginine is not readily available but would be workable in the present invention as well, should it become available. Polyhistidine is available commercially in the levo form at molecular weights ranging from 5,000 to 25,000, and in both the free form and as a hydrochloride salt. Partial or full neutralization of polyarginine or polyhistidine prior to grafting is preferable, just as in the case of polylysine. Polyglutamic acid is available in both levo and dextro forms and in a wide range of molecular weights. It is typically available as the sodium salt. Gamma polyglutamic acid, the form where the peptide bond is between the amino group and the carboxyl group at the end of the side chain, is also widely available, being a major constituent of the Japanese food nattō.

In the best mode as currently understood, a composite reverse osmosis membrane is prepared by the following steps: coating a nonwoven web with a layer of microporous polysulfone, impregnating the polysulfone with aqueous metaphenylenediamine, interfacially contacting the surface of the impregnated web with a nonaqueous solution of trimesoyl chloride or its blend with isophthaloyl chloride, removing residual nonaqueous solvent, coating the fresh surface of the interfacially formed polyamide layer with an aqueous solution of a PAA via a transfer roller, and passing the coated composite membrane through a drying oven before any other processing steps. The drying step promotes the completion of reaction between PAA-borne amine groups with residual acyl halide groups and “hardens” the PAA coating.

From the foregoing description, one skilled in the art is reasonably enabled to ascertain the essential characteristics of this invention and can make various changes and modifications of the invention to adapt it to achieve PAA-grafted reverse osmosis membranes.

1. A composite membrane comprising a porous support, a polyamide discriminating layer deposited thereon, and a poly(amino acid) coating deposited on a surface of the polyamide discriminating layer, the poly(amino acid) coating containing a plurality of pendant amine groups, the composite membrane showing improved fouling resistance by reason of the poly(amino acid) coating.

2. The membrane of claim 1 wherein the poly(amino acid) coating comprises a polymeric form of a member of the group consisting of polylysine, polyarginine, and polyhistidine.

3. The membrane of claim 2 wherein the poly(amino acid) coating comprises a blend of polyglutaric acid with a polymeric form of a member of the group polylysine, polyarginine, and polyhistidine.

4. The membrane of claim 1 wherein the poly(amino acid) coating has a thickness within a range of 20 to 150 angstroms.

5. The membrane of claim 2 wherein the poly(amino acid) coating is linked to the surface of the polyamide discriminating layer by amide linkages.

6. The membrane of claim 2 wherein the poly(amino acid) coating is crosslinked by a treatment with a peroxide.

7. The membrane of claim 2 wherein the poly(amino acid) coating is insolubilized by means of a dialdehyde.

8. A method of modifying a membrane having a polyamide surface layer comprising coating the polyamide surface layer with a polymer of an amino acid, the poly(amino acid) being fixed in place by chemical reaction.

9. The method of claim 8 wherein the coating of the poly(amino acid) is fixed in place by treating with a peroxide reagent to crosslink the poly(amino acid).

10. The method of claim 8 wherein the poly(amino acid) is a polymeric form of a member of the group polylysine, polyarginine, and polyhistidine.

11. The method of claim 10 wherein the poly(amino acid) coating is bonded to the polyamide surface layer by forming amide linkages with pendant amine groups in the poly(amino acid).

12. The method of claim 10 wherein the poly(amino acid) coating is insolubilized on the polyamide surface layer by reacting pendant amine groups in the poly(amino acid) with a dialdehyde.
